(19) United States
(12) Patent Application Publication
(10) Pub. No.: US 2009/0236108 A1
(43) Pub. Date: Sep. 24, 2009

(54) Agricultural Machine

(75) Inventor: Crister Stark, Vaderstad (SE)

Correspondence Address: BIRCH STEWART KOLASCH & BIRCH, PO BOX 747, FALLS CHURCH, VA, 22040-0747, US

(73) Assignee: Vaderstad-Verken Aktiebolag, Vaderstad (SE)

(21) Appl. No.: 12/083,505

(22) PCT Filed: Oct. 5, 2006
(86) PCT No.: PCT/SE2006/050385

§ 371 Date: Jul. 3, 2008

(30) Foreign Application Priority Data
Oct. 14, 2005 (SE) 0502296-7

(51) Int. Cl. A01B 73/06

(52) U.S. Cl. 172/311

(57) ABSTRACT

The invention refers to an agricultural machine (1) for cultivation comprising a frame beam extending on both sides of a centre line in the driving direction of the machine, on which tools (11), preferably planter aggregates, are arranged at relative or group wise generally equal spacing. The agricultural machine has at least one joint for dividing the frame beam into frame beam sections (5, 6) and means (9) for swinging the corresponding frame beam sections on each side of said centre line through a generally equal angle in the horizontal plane, so that neighbouring tools in the working position on the frame beam sections always maintain a generally equal relative spacing.

The present invention refers to an agricultural machine for cultivation comprising a frame beam extending on both sides of a centre line in the driving direction of the machine, on which beam tools, preferably planter aggregates, are arranged at generally equal spacing relative to each other.

Row-sown crops such as vegetables, beet, maize, sunflower, cotton etc. must be sown with a relatively large row spacing and with uniform distance between the seeds. For a long time, professionals have constructed machines for this purpose, these being referred to in English, or rather in American, as planters. These machines have improved in line with the general development in agriculture. A special problem is that different crops must be sown with different row spacings. Maize can be sown with for example 76 cm row spacing, while another crop must be sown with approx. 50 cm row spacing. This problem has been solved in different ways, for example by the farmer owning two machines where the planter aggregates are mounted at different spacings or by the aggregates being re-mounted between sowing of different crops. Another solution used by certain manufacturers is that one folds up alternate aggregates, whereby the row spacing can be doubled. These methods are costly and complicated for the farmer. A further problem is that the planter has to be able to be transported on public roads between different fields. To this end, the machines have been provided with different folding systems. This problem is particularly difficult to resolve for machines supplied in Europe, since these machines have to be folded up to the regulation transport width, often a maximum of three metres.

The object of the present invention is to create an agricultural machine of the initially described type that solves the abovementioned problems.

The object is achieved with an agricultural machine that has been given the characterising features according to Claim 1.

Preferred embodiments of the invention have been given the characteristics described in the subclaims.

If a planter is constructed with a frame of a suitable material, for example a square-profile beam that is both torsion resistant and bending resistant, the frame can be manufactured solely from a homogeneous frame beam. If this frame beam is provided with at least one joint to fold the frame from a straight to an angled position this function can give a machine with the desired advantages.

The planter aggregates which are jointedly mounted at the frame beam alter their relative spacing gradually as the angle between the frame beam sections increases. The aggregates have a parallel movement. If the frame is folded sufficiently the machine can be folded so as to be transportable on public roads, i.e. its width can be made narrower than the maximum permitted.

For very wide machines the frame can be provided with a further joint to allow the frame beam sections to become parallel. By allowing the frame beam sections to be folded to a parallel position the machine can be made very wide.

The machine suitably has wheels that hold the frame at the desired height above the ground. These wheels must run parallel to the driving direction. At least one wheel on each side can be connected with the suspension of an aggregate in such a way that the wheels always runs parallel with the machine regardless of the angle position of the frame.

The invention will be described more closely in the following with reference to the attached drawings, which show preferred embodiments.

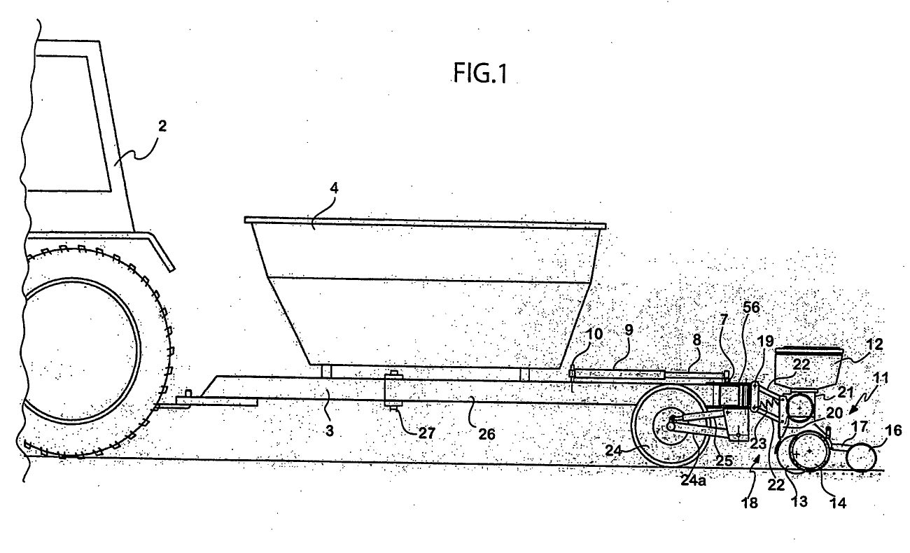

FIG. 1 shows a side view of a first embodiment of a partially shown tractor drawn agricultural machine according to the invention for cultivation by means of planter tools in a position with the greatest spacing between the tools.

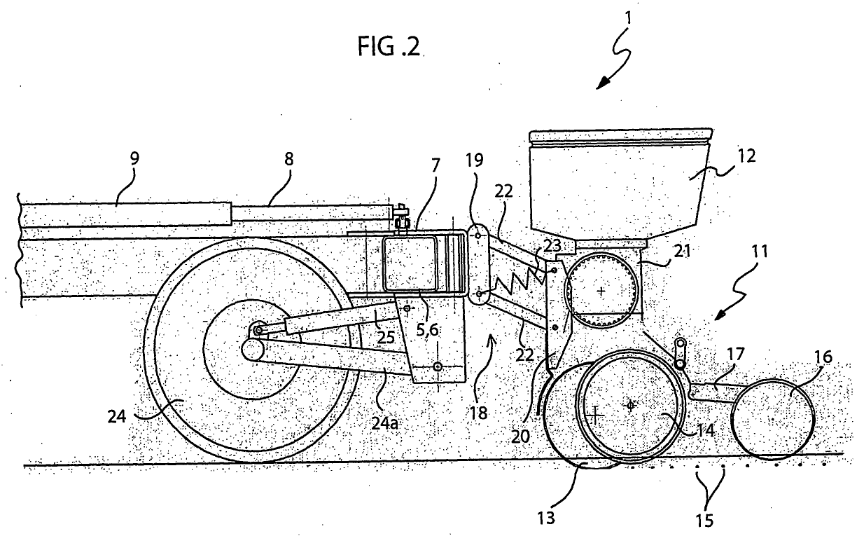

FIG. 2 shows the rear part of the agricultural machine on a larger scale.

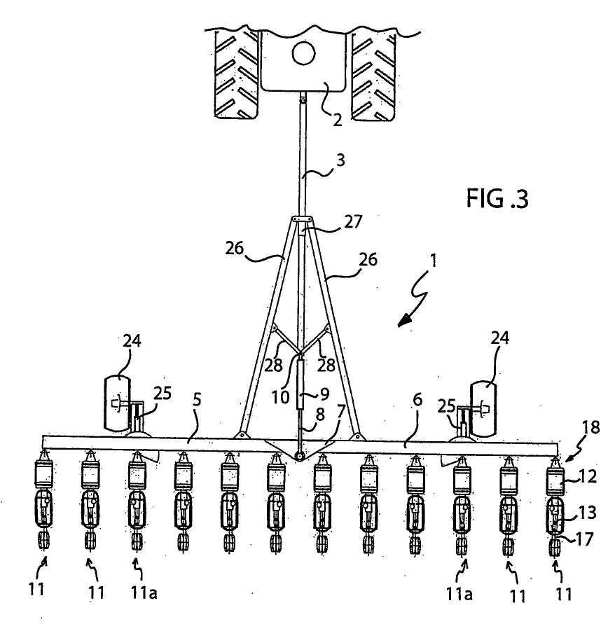

FIG. 3 shows a plane view of the agricultural machine in FIG. 1 where a container has been removed to reveal the suspension of the tool carrying frame beams.

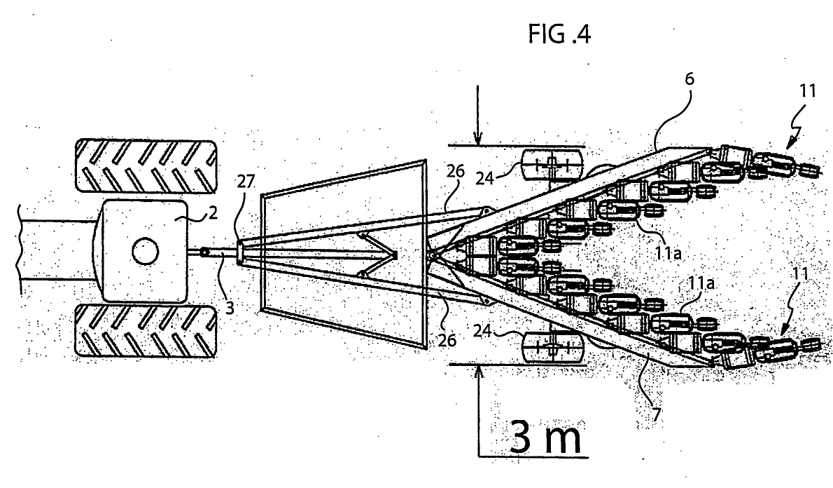

FIG. 4 shows a view from above of the agricultural machine in a transport position.

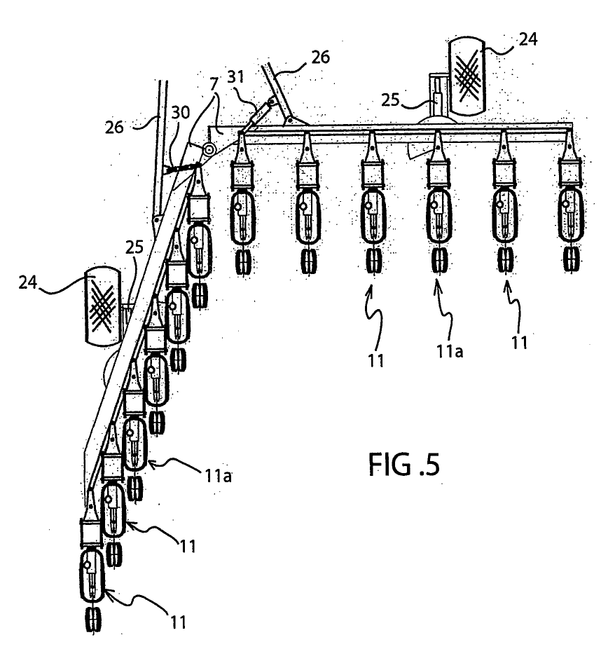

FIG. 5 shows a schematic diagram of the agricultural machine in FIG. 1 where the left side shows a working position with the smallest tool spacing and the right side shows a transport position with the largest spacing between the tools.

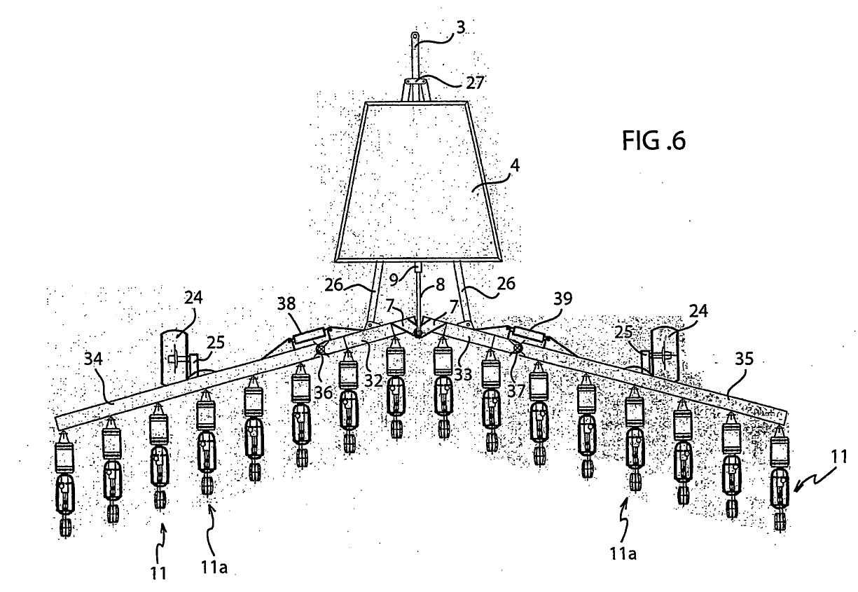

FIG. 6 shows a view from above of a second embodiment of an agricultural machine according to the invention in a working position with smaller spacing between the tools.

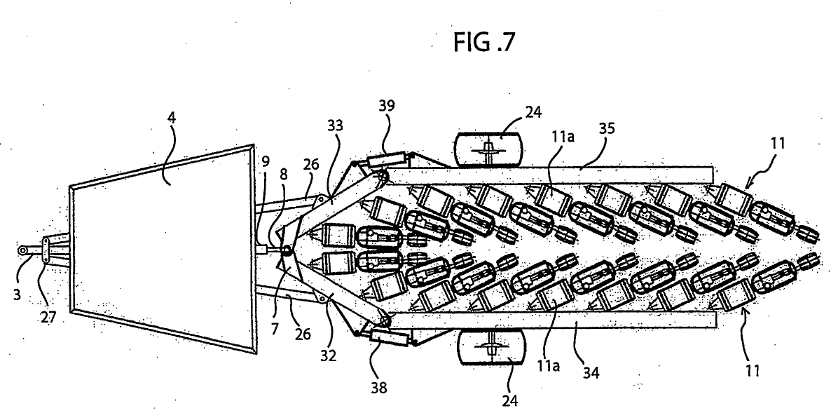

FIG. 7 shows the agricultural machine in FIG. 5 in a transport position with the smallest spacing between the tools.

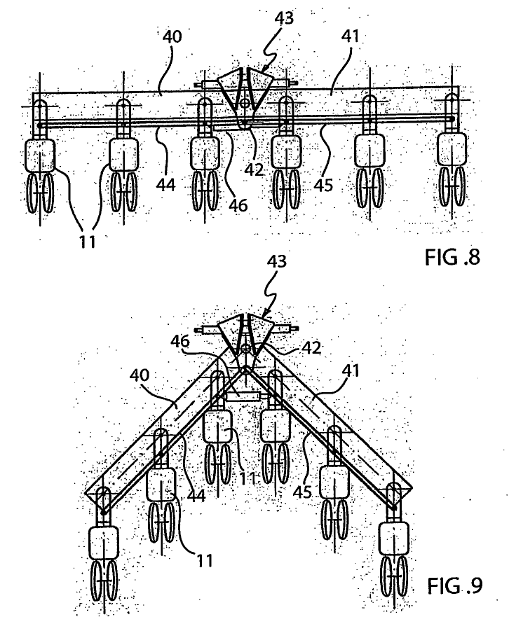

FIG. 8 shows a partly schematic view from above of a third embodiment of an agricultural machine according to the invention in a working position with a total working width that is considerably less than for the embodiments of the agricultural machine shown in FIGS. 1-7.

FIG. 9 shows the agricultural machine in FIG. 8 in another working position with smaller spacing between the tools, which position can also represent a transport position.

Similar parts/details of the embodiments described and depicted in the drawings have been given the same reference number.

FIGS. 1-3 reveal a first embodiment of an agricultural machine 1 for cultivation according to the invention. The machine 1 is shown here fully unfolded, i.e. for maximum row spacing and thereby greatest working width.

The machine 1 is towed by a partially shown tractor 2. On a steering frame 3 a first container 4 is mounted, which can be used either for transport or spreading of fertiliser or for an increased amount of seed. This container can be provided with a not shown spreading device or similar. As an alternative, a device that transfers seed to the planter aggregates can be arranged. Frame beams are fixed at the rear part of the steering frame 3, which frame beams in this embodiment are divided into a left section 5 and a right section 6, which sections are pivotedly mounted at a coupling portion 7, consisting of a generally vertical axis around which the frame beam sections 5, 6 are adapted to swing. One end 8 of a hydraulic piston and cylinder aggregate 9 is similarly pivotedly fastened at the coupling portion 7. The other end 10 of the hydraulic piston and cylinder aggregate 9 is fastened at the steering frame 3 and forms an extension of this towards the tools 11 carried by the frame beam sections. The suspension and controlling of the frame beam sections will be described more closely below.

A preferably even number of tools 11, so-called ‘planter aggregates’, are in the horizontal plane jointedly mounted at the frame beam sections 5, 6 at equal spacing from each other. An even number of planter aggregates means that each frame beam section carries half the aggregates, which brings about a stable equilibrium in the device. One could in an embodiment conceive of at least one centre aggregate arranged at the attachment point between the frame beam sections.

Each planter aggregate is provided with a container 12 for seed, which is fed via coulters 13 down into the soil to a sowing depth that is preinstallable by means of adjustable support wheels 14, which is revealed through the placement of the seed 15 in the soil. A dragwheel 16 is suspended in an arm 17 and so aligned that it closes the seed furrow and recompacts the soil after sowing. Each planter aggregate 11 is suspended in a parallel guide 18 comprising a first bracket 19 fastened at one of the frame beam sections 5 or 6 and a second bracket 20 fastened at the carrying arm 21 of the aggregate. Parallel bars 22 are at their ends pivotally connected to the brackets 19 and 20.

The parallel guide 18 has advantageously an adjustable resilient function in the form of for example a spring 23 for adjusted depressing of the planter aggregate and for stable passage at high speeds, whereby the correct sowing depth is ensured under varying conditions. The hydraulic piston and cylinder aggregate 9 is adapted to set the angle between the frame beam sections 5 and 6. Through the frame beam sections 5 and 6 being displaced in mainly an equally large angle on each side of the horizontal centre line of the machine 1, the spacing between each neighbouring pair of planter aggregates 11 always becomes generally the same regardless of the angle between the frame beam sections.

The machine is supported by two support wheels 24, one on each frame beam section 5, 6. The support wheels 24 are journalled on an arm 24a, which can be mounted in completely similar or partially similar brackets that hold the planter aggregates 11. They are so arranged on the frame beam sections that they follow the swinging of the tools in relation to the frame beam sections. They can also be directly connected to their respective predetermined planter aggregate 11a. Since the wheels 24 are connected to the movement of the aggregates 11 in this way, they are adapted to be controlled so that they always roll parallel with the travel direction of the machine 1. With these support wheels 24 the height of the machine above the ground is regulated, which can occur by having mounted on each support wheel 24 a hydraulic piston and cylinder aggregate 25, which can have pre-adjustable stroke length limiters. When the portion of the machine 1 at the support wheels 24 is lifted by means of the hydraulic piston and cylinder aggregates 25, the planter aggregates 11 are lifted up out of the soil towards a not shown stop so that the machine 1 can be turned on headlands so as to come into position for the next pass without the aggregates 11 disrupting turning and/or damage or wear to the aggregates during the turning movement.

The machine 1 can also be folded together for transport on public roads. When the machine is lowered, the aggregates 11 are lowered until adjustable support wheels 24 rest on the ground, which prevents the aggregates 11 being lowered further. If the frame beam sections continue to be lowered, an increasing weight is placed on the support wheels 14 of the planter aggregates 11 when the spring 23 is extended. The farmer can thus easily adjust the penetrating ability of the machine by setting the frame height by means of the hydraulic piston and cylinder aggregates 25 at each support wheel 24. The frame height can be varied manually during work or according to a predetermined schedule, which can be varied according to soil type, preceding crop etc. This function can suitably be controlled by GPS.

The piston and cylinder aggregate 9 shown in FIG. 1-4, with which the angle between the frame bean sections 6, 7 can be set, can be designed (not shown) so that it is given preset stop positions or provided with an electronic measuring rod, which electrically reports the actual position to a check box. This check box can control one or more hydraulic valves with the aim of locking the cylinder in a predetermined position.

The piston and cylinder aggregate 9 can be inbuilt in such a stable way that it acts as an angle scaler, i.e. it ensures that both frame beam sections are folded symmetrically around the centre line of the machine. Another alternative is that the machine is provided with a guide or similar with corresponding function. FIG. 3 shows an embodiment where two bars 26 are mounted at an angle with their front ends pivotally fastened at a part 27 displaceable along the steering frame 3 and at their rear ends pivotally fastened at the frame beam sections. For the sake of stability, two further bars 28 can be pivotally mounted between the steering frame 3 and the bars 26 forming an angle in the opposite direction relative to the bars 26. It is presumed that the connection between the steering frame 3 and the front end 10 of the piston and cylinder aggregate 9 is both torsion resistant and bending resistant.

FIG. 5 shows schematically a hypothetical diagram of the rear part of the agricultural machine, where one side has been folded in for transport and one side is in the working position fully extended for the greatest row spacing. The diagram shows how the planter aggregates 11 and the support wheels 24 are connected to a parallel bar 29. This parallel bar is maneuvered with a link 30 or a hydraulic cylinder 31 in such a way that the planter aggregates 11 and the wheels 24 are always parallel to the driving direction in a working position. In the transport position the planter aggregate and the wheels are advantageously also parallel.

FIGS. 6 and 7 show a large machine with a double folding frame. Here parallel motion becomes more complicated. Parallel motion can for example be achieved through a link device or a hydraulic system. The frame beam sections in this embodiment are divided into two further outer sections, so that on each side of the centre of the machine an inner 32, 33 and an outer 34, 35 frame beam section are pivotally connected with each other at 36 and 37. The angle between on one side the inner and outer frame beam sections 32 and 34 and on the other side between the inner and outer frame beam sections 33 and 35 is achieved by means of a piston and cylinder aggregate 38 and 39, respectively. Since the space is limited between the frame beam sections 32, 34 and 33, 35 the planter aggregates (all or some) have to be angled so that they are not parallel to the driving direction. Furthermore the wheels 24 must be able to swing more than the corresponding tool 11a to get an orientation that is parallel to the driving direction in the transport position (FIG. 7).

If one considers FIG. 6, i.e. where an angle is created between the frame beam sections so that a smaller working spacing is achieved between the planter aggregates it is apparent that if all aggregates start at the same time an uneven line will appear when the plants emerge from the soil. In sowing of maize and other row-sown crops, the farmer is keen to ensure that the start and stop line at the headland is straight for the greatest soil use and to avoid double sowing. The machines are therefore provided with a not shown control device that first starts the two central aggregates and thereafter at uniform time intervals the subsequent planter aggregates to give a straight sowing line. This involves a sequence-controlled start of metering out of the seed. The machines can have mechanical drive with couplings that activate the planter aggregates sequentially. The machines can also have electrical drive of the aggregates. The machines commonly have speed measurements with radar, which can also be done in other ways for example mechanically or with GPS. By means of the radar speed measurement it is easy to calculate the time interval at which the aggregates should be started. The converse applies when metering out is stopped at the end of the field.

FIGS. 8 and 9 show a third embodiment of an agricultural machine 1 according to the invention. The agricultural machine 1 has a frame divided into two frame beam sections 40 and 41, which overlap each other at the drawbar, so that they are journalled in in a common pivot 42. This machine has a coupling 43, which is intended to be connected directly to the three-point-lift of the tractor. The planter aggregates 11 are turnably fastened at the frame beam sections 40 and 41 at generally the same relative spacing from each other. Stabilising bars 44 and 45 are arranged parallel to the frame beam sections 40 and 41, respectively, and at a distance from them. The planter aggregates 11 are pivotally fastened at the bars 44 and 45 at a predetermined distance from the beams so that parallel motion is achieved. In the position in which the seed rows created by the planter aggregates have acquired a predetermined spacing between each other in the longitudinal direction, the row spacing is kept constant by means of the bars 44 and 45 and a piston and cylinder aggregate 46. The machine can also be provided with one or more support wheels, for example one in the centre, for use in both the working and transport position or in either one of these positions. When the spacing between the aggregates has to be made smaller the positions of the frame beam sections 40 and 41 are altered from the position shown in FIG. 8. for example to the position shown in FIG. 9, wherein is shown a position that can either act as a working position with smaller spacing between the planter aggregates or a transport position where the width of the agricultural machine is less than the regulation transport width.

The agricultural machine according to the invention can be modified within the frame of the attached Claims. The embodiment according to FIGS. 1-3 shows twelve planter aggregates (six on each frame beam section) and the embodiment according to FIGS. 6 and 7 shows sixteen planter aggregates, but this number can be both increased and decreased within the frame of the following Claims, the main point is that they are mounted along the frame beam sections at generally similar relative spacings and preferably equal in number on each side of a conceptual centre line in the driving direction. An essential characteristic of the invention is that the joints between the beam sections lie in general on the centre line of the machine. The piston and cylinder aggregates shown in the drawings can be any type of adjustment means whatsoever. The tools do not have to be planter aggregates, but can also be other types of cultivation tools, such as hoes, cultivator tines, rotating discs or other working means.

1. Agricultural machine for cultivation comprising a frame beam (5, 6; 32, 33, 34, 35, 40, 41) extending on both sides of a centre line in the driving direction of the machine, on which tools (11), preferably planter aggregates, are arranged at relative or groupwise generally equal spacing, characterized in that it comprises a joint in the form of a generally vertical axis that is disposed generally on said centre line to divide the frame beam into frame beam sections (5, 6; 32, 33, 34, 35, 40, 41) and means (9, 46) for swinging on each side of said centre line the corresponding frame beam sections through a generally equal angle in the horizontal plane, so that neighbouring tools (11) in the working position on the frame beam sections always maintain a generally equal relative spacing.

2. Agricultural machine according to claim 1, characterized in that said tools (11) are in the horizontal plane pivotally connected with said frame beam sections (5, 6; 32, 33, 34, 35, 40, 41).

3. Agricultural machine according to claim 1, characterized in that it comprises controlling bars (29, 44, 45) which are arranged alongside each frame beam section (5, 6; 32, 33, 34, 35, 40, 41) and control the tools (11), which bars can be so displaced at swinging of the frame beam sections that the tools maintain their orientation in relation to the driving direction.

4. Agricultural machine according to claim 3, characterized in that said bars (29, 44, 45) are provided to be displaced by means of link connections (30) or piston and cylinder aggregates (31, 46).

5. Agricultural machine according to claim 1, characterized in that said means comprises an adjustment means (9, 46), which forms an elongation of the steering frame that is attachable to a draught vehicle, such as a tractor (2) and that bars (26, 28) are coupled between the steering frame and said frame beam sections (5, 6; 32, 33) so as to bring about equal displacement of the frame beam sections on each side of said centre line.

6. Agricultural machine according to claim 1, characterized in that said frame beam sections (5, 6; 32, 33, 34, 35) are provided to be swung from a position where the frame beams are generally at right angles to the driving direction backwards to a transport position, whereby between these positions said frame beams can be locked in predetermined working positions.

7. Agricultural machine according to claim 5, characterized in that said transport position allows the machine (1) to adopt a width such that it is transportable on public roads.

8. Agricultural machine according to claim 1, characterized in that said frame beam sections (5, 6; 32, 33, 34, 35) each have an additional joint (36, 37) for reducing the width of the machine further.

9. Agricultural machine according to claim 1, characterized in that adjustable support wheels (24) are arranged on a frame beam section (5, 6; 34, 35) on each side of said centre line, which support wheels have means, preferably one adjustment means (25) each to raise and lower the machine and are so suspended that they are always orientated in the driving direction of the machine and that said adjustable support wheels (24) can be fixed at a corresponding tool (11a) on the respective frame beam section (5, 6; 34, 35).

10. Agricultural machine according to claim 1, characterized in that it comprises coupling members (43) fastened directly at said frame beam sections (40, 41) in order to connect the machine (1) directly to the linkage of the draught vehicle and that said means is comprised of an adjustment means (45) acting between said frame beam sections.

11. Agricultural machine according to claim 2, characterized in that it comprises controlling bars (29, 44, 45) which are arranged alongside each frame beam section (5, 6; 32, 33, 34, 35, 40, 41) and control the tools (11), which bars can be so displaced at swinging of the frame beam sections that the tools maintain their orientation in relation to the driving direction.

12. Agricultural machine according to claim 2, characterized in that said means comprises an adjustment means (9, 46), which forms an elongation of the steering frame that is attachable to a draught vehicle, such as a tractor (2) and that bars (26, 28) are coupled between the steering frame and said frame beam sections (5, 6; 32, 33) so as to bring about equal displacement of the frame beam sections on each side of said centre line.

13. Agricultural machine according to claim 3, characterized in that said means comprises an adjustment means (9, 46), which forms an elongation of the steering frame that is attachable to a draught vehicle, such as a tractor (2) and that bars (26, 28) are coupled between the steering frame and said frame beam sections (5, 6; 32, 33) so as to bring about equal displacement of the frame beam sections on each side of said centre line.

14. Agricultural machine according to claim 4, characterized in that said means comprises an adjustment means (9, 46), which forms an elongation of the steering frame that is attachable to a draught vehicle, such as a tractor (2) and that bars (26, 28) are coupled between the steering frame and said frame beam sections (5, 6; 32, 33) so as to bring about equal displacement of the frame beam sections on each side of said centre line.

15. Agricultural machine according to claim 2, characterized in that said frame beam sections (5, 6; 32, 33, 34, 35) are provided to be swung from a position where the frame beams are generally at right angles to the driving direction backwards to a transport position, whereby between these positions said frame beams can be locked in predetermined working positions.

16. Agricultural machine according to claim 3, characterized in that said frame beam sections (5, 6; 32, 33, 34, 35) are provided to be swung from a position where the frame beams are generally at right angles to the driving direction backwards to a transport position, whereby between these positions said frame beams can be locked in predetermined working positions.

17. Agricultural machine according to claim 4, characterized in that said frame beam sections (5, 6; 32, 33, 34, 35) are provided to be swung from a position where the frame beams are generally at right angles to the driving direction backwards to a transport position, whereby between these positions said frame beams can be locked in predetermined working positions.

18. Agricultural machine according to claim 5, characterized in that said frame beam sections (5, 6; 32, 33, 34, 35) are provided to be swung from a position where the frame beams are generally at right angles to the driving direction backwards to a transport position, whereby between these positions said frame beams can be locked in predetermined working positions.

19. Agricultural machine according to claim 2, characterized in that said frame beam sections (5, 6; 32, 33, 34, 35) each have an additional joint (36, 37) for reducing the width of the machine further.

20. Agricultural machine according to claim 3, characterized in that said frame beam sections (5, 6; 32, 33, 34, 35) each have an additional joint (36, 37) for reducing the width of the machine further.
